(19) United States
(12) Patent Application Publication
(10) Pub. No.: US 2007/0069420 A1
(43) Pub. Date: Mar. 29, 2007

(54) Method and apparatus to generate a seal between metallic and plastic materials

(75) Inventors: Kazimierz L. Kozyra, Olympia, WA (US); Daniel P. Carter, Olympia, WA (US); Michael T. Crocker, Portland, OR (US)

Correspondence Address: SCHUBERT, OSTERRIEDER & NICKELSON, PLLC;c/o PORTFOLIOIP, P.O. BOX 52050, MINNEAPOLIS, MN, 55402, US

(73) Assignee: Intel Corporation

(21) Appl. No.: 11/238,441

(22) Filed: Sep. 29, 2005

(51) Int. Cl. B29C 45/14

(52) U.S. Cl. 264/259; 29/527.1

(57) ABSTRACT

Generally speaking, a system with a metallic component and a thermoplastic component is disclosed. The metallic component may include a metallic outer surface and the thermoplastic component may be formed around the metallic outer surface to create a seal between the thermoplastic housing and the metallic component. In some embodiments, the thermoplastic component may include an inner surface and an outer surface where the inner surface is formed adjacent to an in contact with the metallic outer surface. Embodiments may also include a sealing ring positioned on the outer surface of the thermoplastic housing to provide a compressive spring force to the thermoplastic housing, where the force applied to the thermoplastic housing improves the seal between the thermoplastic component and the metallic component. In a further embodiment, the metallic component is a metallic cold plate and the thermoplastic component is a thermoplastic pump housing. Other embodiments are disclosed and claimed.

### FIELD

The present invention is in the field of seals. More particularly, the present invention relates to a method and apparatus to generate a seal between metallic and plastic materials, such as between a metallic cold plate and a thermoplastic housing.

### BACKGROUND

Systems that require the transfer of fluid from one location to another, such as liquid cooling systems for heat-generating components of computer systems, typically are comprised of a variety of parts, many of which are exposed to liquids such as a cooling fluid. Often, the interface between different parts that is exposed to a fluid is sealed to prevent or minimize leakage of the fluid. Depending on the type of system and the type of fluid, leakage of the fluid from the system may result in performance degradation, increased maintenance requirements, or system failure. A cooling fluid leak in a liquid cooling system, for example, can result in a reduction in cooling capacity, reduced performance, or even failure of the component being cooled. Effective seals are integral to the performance of systems containing any type of fluid. The problem of providing an effective seal between two components is exacerbated when the two components are made of different materials. Many metals, for example, do not bond with plastics, limiting the types of seals that are appropriate for use between metallic and plastic components. Additionally, different materials often have different rates of thermal expansion. This can result in high loads between the parts or gapping at their interface.

A common solution to providing seals between metallic and plastic components is to use an O-ring positioned in between the components. Such a solution, however, requires the use of tight tolerances or hardware to maintain compression on the O-ring sealing element, resulting in a costly, labor intensive and possibly unreliable solution. Another sealing solution is to position a gasket between the metallic and plastic components. Gaskets, however, typically require the use of bonding compounds to provide a proper seal and, accordingly, gaskets share similar disadvantages of cost, labor, and potential unreliability as do O-ring seals. The cost and complexity of metallic-plastic seals can be a significant factor in the cost, required labor, and reliability of a larger system, and reductions in the cost and complexity of seals can therefore reduce the cost of complexity of the systems in which they are found. As an example, the relatively high cost and complexity of liquid cooling systems result in their use primarily with higher-end computer systems. Reducing the cost and complexity of seals used in a liquid cooling system for heat-generating components can make liquid cooling systems suitable for a wider range of systems.

### BRIEF DESCRIPTION OF THE DRAWINGS

Advantages of the invention will become apparent upon reading the following detailed description and upon reference to the accompanying drawings in which like references may indicate similar elements:

FIG. 1 depicts an isometric cut-away view of a cold plate system with a cold plate, thermoplastic housing, and sealing ring according to one embodiment;

FIG. 2 depicts an enlarged cut-away side schematic view of the seal region of the cold plate system of FIG. 1 according to one embodiment;

FIG. 3 depicts a side cut-away schematic view of a fluid fitting system with a metallic fitting, a thermoplastic fitting, and sealing ring according to one embodiment;

FIG. 4 depicts a flowchart of an embodiment to provide a seal between a metallic component and a plastic component; and

FIG. 5 depicts a flowchart of an embodiment to create a plastic component around a metallic component and to seal the interface between them.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, a system with a metallic component and a thermoplastic component is disclosed. The metallic component may include a metallic outer surface and the thermoplastic component may be formed around the metallic outer surface to create a seal between the thermoplastic component and the metallic component. In some embodiments, the thermoplastic component may include an inner surface and an outer surface where the inner surface is formed adjacent to an in contact with the metallic outer surface. Embodiments may also include a sealing ring positioned on the outer surface of the thermoplastic housing to provide a compressive spring force to the thermoplastic housing, where the force applied to the thermoplastic housing improves the seal between the thermoplastic component and the metallic component. In a further embodiment, the metallic component is a metallic cold plate and the thermoplastic component is a thermoplastic pump housing.

Another embodiment comprises a cold plate system with a metallic cold plate and a thermoplastic component. The metallic cold plate may include a cold plate outer surface and the thermoplastic component may be formed around the metallic cold plate to create a seal between the thermoplastic housing and the metallic cold plate. In some embodiments, the thermoplastic housing may include an inner surface and an outer surface where the inner surface is formed adjacent to an in contact with the cold plate outer surface. Embodiments may also include a sealing ring positioned on the thermoplastic outer surface to provide a compressive spring force to the thermoplastic housing, where the force applied to the thermoplastic housing at least partially at the seal between the thermoplastic housing and the metallic cold plate. In a further embodiment, the thermoplastic housing comprises a housing structure region to substantially support structural loads on the thermoplastic housing and a housing sealing region that is thinner than the housing structure region, where the sealing ring is positioned on a portion of the thermoplastic outer surface associated with the housing sealing region.

Another embodiment comprises a method for joining a plastic component to a metallic component. Some embodiments of the method may include placing the metallic component into an injection plastic mold and injecting plastic into the injection plastic mold to form a plastic component around the metallic component. Embodiments may also include installing a sealing ring around at least a portion of the plastic component to provide a seal between the metallic component and the plastic component. In a further embodiment, installing the sealing ring may include expanding the sealing ring and placing the expanded sealing ring around at least a portion of the plastic component.

Another embodiment comprises a method for sealing an interface between a plastic component and a metallic component. Some embodiments of the method may include forming a plastic component around the metallic component and creating a seal at an interface between the plastic component and the metallic component. Embodiments may also include applying pressure to the seal to maintain the interface between the plastic component and the metallic component.

The disclosed system and methodology may advantageously provide for a system for joining and sealing metallic and plastic components. In one example, a cold plate system includes a thermoplastic housing formed around a cold plate with a sealing ring positioned over at least part of the thermoplastic housing. By forming the thermoplastic housing directly around the cold plate, the plastic of the thermoplastic housing may be advantageously precisely formed around the cold plate, reducing or eliminating any gaps between the two and providing a seal between them. Pressure applied by the sealing ring keeps the thermoplastic housing in contact with the cold plate even during thermal cycles or other perturbations. As will be described in more detail subsequently, the disclosed embodiments may thus provide an effective, efficient and relatively low-cost mechanism for joining plastic and metal components and providing a seal between them.

Various embodiments of the present invention provide systems and methods for generating a seal between metallic and plastic materials. The following description provides specific details of certain embodiments of the invention illustrated in the drawings to provide a thorough understanding of those embodiments. It should be recognized, however, that the present invention can be reflected in additional embodiments and may be practiced without some of the details in the following description. In other instances, well-known structures and functions have not been shown or described in detail to avoid unnecessarily obscuring the description of the embodiments of the invention. While specific embodiments will be described below with reference to particular configurations and systems, those of skill in the art will realize that embodiments of the present invention may advantageously be implemented with other substantially equivalent configurations and/or systems.

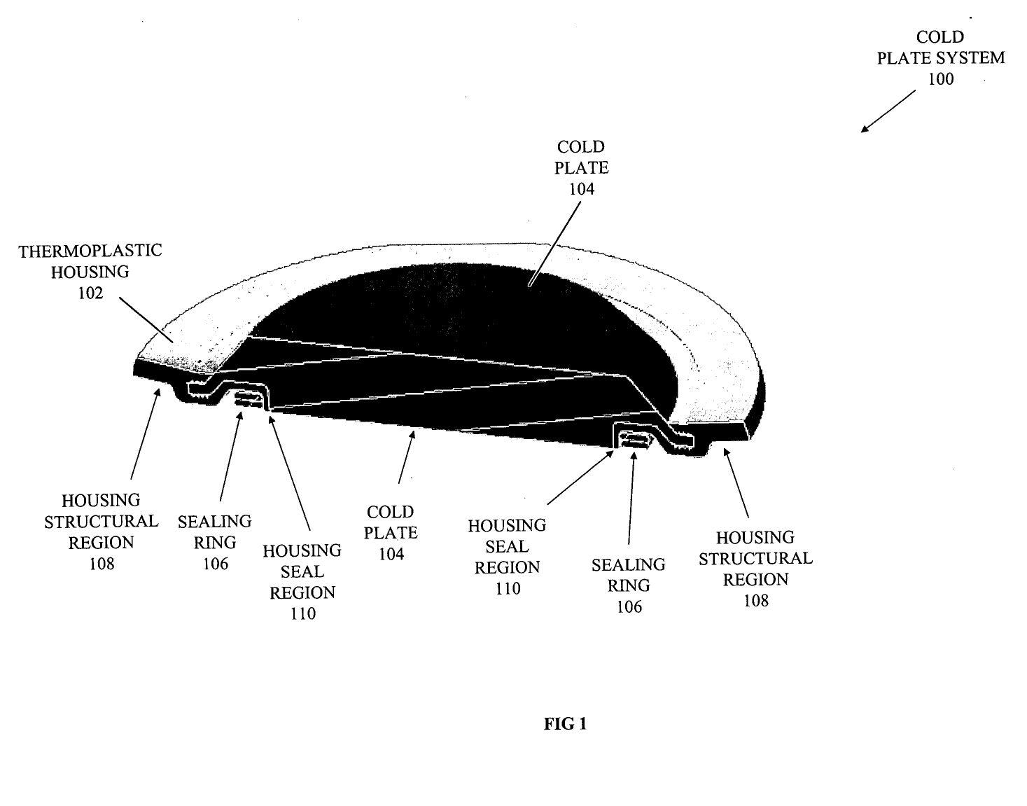

Turning now to the drawings, FIG. 1 depicts an isometric cut-away view of a cold plate system with a cold plate, thermoplastic housing, and sealing ring according to one embodiment. The cold plate system 100 of FIG. 1 includes a thermoplastic housing 102 formed around the periphery of a cold plate 104 with a sealing ring 106 positioned over at least part of the thermoplastic housing 102 to assist in forming a seal between the thermoplastic housing 102 and the cold plate 104. By forming the thermoplastic housing 102 directly around the cold plate 104, the plastic of the thermoplastic housing 102 may be advantageously precisely formed around the cold plate 104, reducing or eliminating any gaps between the two and providing a seal between them. The formation of the thermoplastic housing 102 in this fashion may provide a substantially perfect dimensional and geometric relationship at the interface between the metal and the plastic. The sealing ring 106 positioned outside the thermoplastic housing 102 may apply pressure to the thermoplastic housing 102, keeping the thermoplastic housing 102 in contact with the cold plate 104 during thermal cycles or other perturbations to the interface and thus maintaining the seal. The sealing ring 106, for example, may keep the thermoplastic housing 102 pressed against the cold plate 104 even during differential expansion or contraction of the two materials during thermal cycles. As will be described in more detail subsequently, the cold plate system 100 may therefore provide an effective and efficient mechanism for joining plastic and metal components and providing a seal between them. The disclosed system may also be significantly less expensive than alternative sealing methods using O-rings or gaskets, requiring less expense in materials and assembly.

The thermoplastic housing 102 may be composed of any natural or synthetic plastic, including but not limited to any of various organic compounds produced by polymerization or any polymer. The cold plate 104, on the other hand, may be comprised of any type of thermally conductive metal such as copper. In one embodiment, the thermoplastic housing 102 may be formed around the interface geometry of the cold plate 104 in an insert injection molding process as described in more detail in relation to FIG. 5. The thermoplastic housing 102 may be, in one embodiment, part of a larger system, such as a pump for a liquid cooling system. A liquid cooling system for high performance processors or other computer system components, for example, may use one or more pumps to move cooling fluid through the system. The liquid cooling system may include a cold plate 104 thermally coupled to a heat-generating component. In this solution, the pump (not shown in its entirety) may pump cooling fluid through or over the cold plate 104, allowing heat to be transferred from the component to the cooling fluid through the cold plate 104, after which the heat is removed from the cooling fluid via a heat exchanger and then returned to the liquid cooling system. Liquid cooling using a cold plate 104 can be more effective than solid conduction cooling methods and can also provide additional flexibility in the size and location of the heat exchanger, as the system can pump the heated fluid to a heat exchanger located in a more desirable location. The cold plate system 100 depicted in FIG. 1 depicts a thermoplastic housing 102 of a pump integrated with a cold plate 104, with the thermoplastic housing 102 effectively positioned between the cold plate 104 and a hole in the pump housing in which the cold plate 104 is positioned. A seal between the thermoplastic housing 102 and the cold plate 104 retains cooling fluid within the pump itself.

The sealing ring 106 may comprise any type of device to provide a compressive spring force to the thermoplastic housing 102. In one embodiment, the sealing ring 106 is a double turn laminar metallic ring. Double turn laminar metallic rings generally provide 360 degrees of contact and provide a higher clamping force (i.e., a compressive pressure) than single turn laminar metallic rings. In this embodiment, the double turn laminar metallic ring may be installed by expanding the ring during assembly and releasing the expanded ring from an assembly tool onto the thermoplastic housing 102 perimeter. The double turn laminar metallic ring may act as a spring clamp and as a backbone for the plastic material, providing a spring force (and thus pressure) to the thermoplastic housing 102, pushing it against the cold plate 104 even during temperature fluctuations. Double turn laminar metallic rings may still provide a clamping force after creep of the plastic material (such as those resulting from temperature fluctuations) results in “thinning” of the plastic, as the rings will continue to compress the plastic against the metallic surface of the cold plate 104. While double turn laminar metallic rings are depicted in FIG. 1, one skilled in the art will recognize that other types of sealing rings 106, such as single turn laminar metallic rings, that can apply a compressive spring force are possible and within the scope of the invention. Any sealing ring 106 that provides a clamping force at multiple diameters (to account for creep of the plastic) may advantageously be used as part of the cold plate system 100. In another example, the sealing ring 106 may be a metallic band wrapped around the thermoplastic housing 102. A metallic band may provide a sufficient clamping force, but may lose some compressive force in the event of creep of the plastic material as it does not apply consistent force at multiple diameters.

The cold plate system 100 of the depicted embodiment is cylindrical in geometry. In this embodiment, the at least partially cylindrical thermoplastic housing 102 wraps entirely around an at least partially cylindrical cold plate 104, both of which may be circular in cross section. The sealing ring 106, which may be circular in this embodiment, may apply pressure around the circumference of the thermoplastic housing 102 where it presses against the cold plate 104. While a cylindrical cold plate system 100 is depicted, one skilled in the art will recognize that other shapes or configurations are possible, including elliptical shapes or shapes with sharp corners (e.g., squares, triangles, rectangles, etc.). Generally speaking, however, sharper curves or corners result in more difficulties in providing uniform sealing and pressure distributions from the sealing ring 106. For example, a sealing ring 106 may have difficulty consistently providing the desired pressure near a sharp corner of a square thermoplastic housing 102, resulting in potential leaks in the seal. A circular sealing ring 106, on the other hand, may advantageously provide a substantially uniform pressure to the thermoplastic housing 102 across its circumference.

In the depicted embodiment of FIG. 1, the thermoplastic housing 102 includes both a housing structural region 108 and a housing seal region 110 to help separate the structural portion of the thermoplastic housing 102 from the seal. The housing structural region 108 of the thermoplastic housing 102 supports a majority of or substantially all of the structural loads on the thermoplastic housing 102, such as joint loading loads, so that the housing seal region 110 is isolated from the loads. The housing seal region 110 (which includes the seal between the plastic and metal) of the thermoplastic housing 102 is thinner in structure than the housing structural region 108 and, because of its position inward and its relative thinness, may be substantially isolated from the structural forces supported by the housing structural region 108. The housing seal region 110 may also transfer compression loads from the sealing ring 106 to the cold plate 104 because of its relatively small structural strength. By isolating the housing seal region 110 from many of the structural loads of the cold plate system 100, the effectiveness and longevity of the metallic-plastic seal may advantageously be increased. Isolating structural loads from the seal may be particularly useful when the thermoplastic housing 102 is subjected to a pre-load such as in the cold plate system 100.

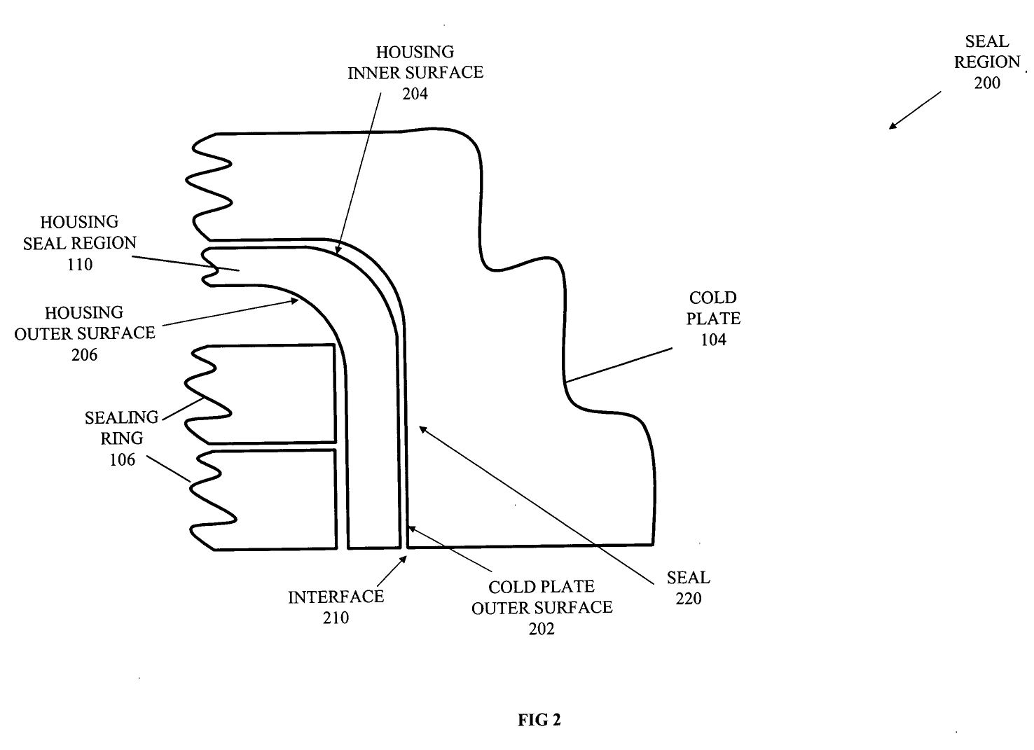

FIG. 2 depicts an enlarged side cut-away schematic view of the seal region of the cold plate system of FIG. 1 according to one embodiment. The seal region 200 of FIG. 2, which is not to scale, includes the housing seal region 110 of the thermoplastic housing 102 formed around the periphery of the cold plate 104 with a sealing ring 106 applying pressure to the housing seal region 110 to push it against the cold plate 104. The cold plate 104 of FIG. 2 includes a cold plate outer surface 202 facing outwards from the center of the cold plate 104. A housing inner surface 204 of the housing seal region 110 may be in contact with the cold plate outer surface 202 at an interface 210 to form a seal 220. The housing seal region 110 may also include a housing outer surface 206 opposite the housing inner surface 204. The sealing ring 106 of FIG. 2 may apply pressure to the housing outer surface 206 of the housing seal region 110, resulting in the housing inner surface 204 being pushed against the cold plate outer surface 202 at the interface 210 and providing a more effective seal 220. While gaps are shown in FIG. 2 at the interface 210 and between the sealing ring 106 and housing outer surface 206 for the purpose of clarity, the surfaces may be at least partially touching each other so as to impart the forces between them and to provide the seal.

The interface 210 created between the housing inner surface 204 and the cold plate outer surface 202 forms a seal 220 to fluid passing between the thermoplastic housing 102 and cold plate 104. The effectiveness of the seal 220 may depend on a variety of factors, including the composition and surface of the materials, the pressure applied by the sealing ring 106, the type of fluid, any temperature fluctuations, and the like. For example, a polished (and thus smoother) cold plate outer surface 202 may form a better seal 220 with the housing inner surface 204 when the thermoplastic housing 102 is formed around the cold plate 104. A smoother cold plate outer surface 202 is likely to result in fewer gaps between the cold plate 104 and thermoplastic housing 102. In another example, a tighter sealing ring 106 may provide increased pressure to the housing seal region 110 and thus form a tighter seal 220 at the interface 210, as fluids will have a more difficult time escaping through the interface 210 if the housing inner surface 204 is more tightly compressed against the cold plate outer surface 202.

Degradation of performance resulting from creep of the plastic material of the thermoplastic housing 102 may advantageously be reduced by using the double turn laminar metallic ring for the sealing ring 106. In the event that the thickness of the housing seal region 110 (the distance between the housing inner surface 204 and outer surface 206) is reduced by thermal cycles, the double turn laminar metallic ring may still provide the same amount of force as before, keeping the pressure applied to the interface 210 constant in spite of creep and providing a consistent spring force. Some other types of sealing rings 106 may reduce the applied pressure in the event of creep and thinning of the housing seal region 110.

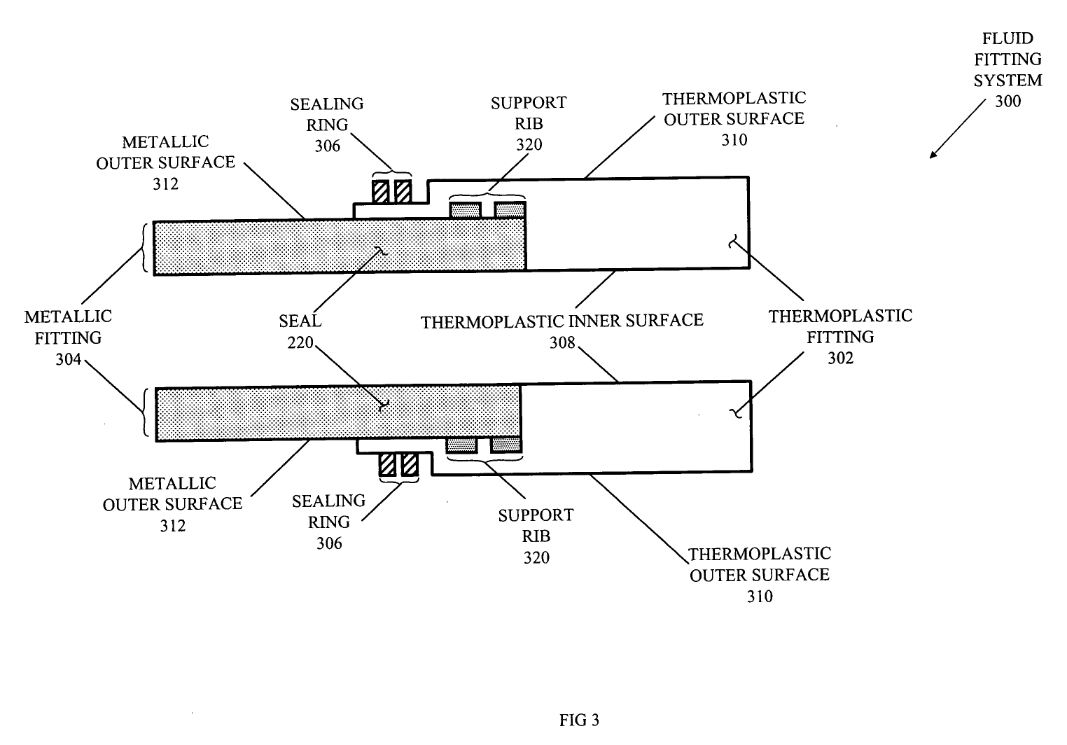

FIG. 3 depicts a side cut-away schematic view of a fluid fitting system with a metallic fitting, a thermoplastic fitting, and sealing ring according to one embodiment. The fluid fitting system 300 of FIG. 3 includes a cylindrical thermoplastic fitting 302 formed around the periphery of a cylindrical metallic fitting 304 with a sealing ring 306 positioned over part of the thermoplastic fitting 302 to assist in forming a seal 220 between the thermoplastic fitting 302 and the metallic fitting 304. The fluid fitting system 300 of FIG. 3 may serve as sealed fitting between a metallic component and a plastic component so that fluid may pass through the fluid fitting system 300 without leaking through the connection between the metallic and plastic surfaces. The fluid fitting system 300 of FIG. 3 may be used as a hydraulic fitting, a fuel fitting, or a fitting for other liquids. One skilled in the art will recognize that, in addition to the cold plate system 100 and fluid fitting system 300, the apparatus and method of the disclosed embodiments may be applicable to any metallic-plastic interface in which a fluid seal is desired. As described previously, the disclosed apparatus and method may be particularly advantageous for cylindrical geometries.

As in the cold plate system 100, the thermoplastic fitting 302 may be precisely formed directly around the metallic fitting 304, reducing or eliminating any gaps between the two and providing a seal between them. Once the thermoplastic fitting 302 is formed, a thermoplastic inner surface 308 of the thermoplastic fitting 302 may be in contact with a metallic outer surface 312 of the metallic fitting 304. The formation of the thermoplastic fitting 302 in this fashion may provide a substantially perfect dimensional and geometric relationship at the interface between the metal and the plastic. The sealing ring 306 positioned outside the thermoplastic fitting 302 in contact with a thermoplastic outer surface 310 may apply pressure to the thermoplastic fitting 302, keeping the thermoplastic inner surface 308 in contact with the metallic outer surface 312 during thermal cycles or other perturbations to the interface. The sealing ring 306, for example, may keep the thermoplastic fitting 302 pressed against the metallic fitting 304 even during differential expansion or contraction of the two materials during thermal cycles. The fluid fitting system 300 may thus provide an effective and efficient mechanism for joining plastic and metal components and providing a seal between them. The disclosed system may also be significantly less expensive than alternative sealing methods using O-rings or gaskets, requiring less expense in materials and assembly.

The thermoplastic fitting 302 may be composed of any natural or synthetic plastic, including but not limited to any of various organic compounds produced by polymerization or any polymer. The metallic fitting 304, on the other hand, may be comprised of any type of thermally conductive metal such as copper. In one embodiment, the thermoplastic fitting 302 may be formed around the metallic fitting 304 in an insert injection molding process as described in more detail in relation to FIG. 5. The sealing ring 306 may comprise any type of device to provide a compressive spring force to the thermoplastic fitting 302, such as a double turn laminar metallic ring, as described in relation to the sealing ring 106 of FIGS. 1 and 2. The sealing ring 306 may cover any width of the thermoplastic outer surface 110 sufficient for the desired seal quality. Similarly, the sealing ring 306 may be tuned with different amounts of compressive spring force depending on the applied pressure on the seal desired.

The thermoplastic fitting 302 of the fluid fitting system 300 of FIG. 3 does not have a structural region and seal region as does the thermoplastic housing 102 of FIG. 1. As the thermoplastic fitting 302 will not likely be subjected to structural loads because of the fluid fitting system design 300 (i.e., no pre-loading), the advantages of separate thermoplastic regions is minimal and the desire to isolate the seal is likely reduced. The thermoplastic fitting 302 may be thinner in the area of the seal 220, however, to assist in isolating structural loads from the sealing interface, allowing the sealing ring 306 to provide a more effective seal. A thinner thermoplastic fitting 302 in the seal 220 region reduces structural loads at the seal 220 and allows sealing ring 306 loads to be passed through the plastic and reacted instead in the metal of the metallic fitting 304. In this embodiment, the metallic fitting 304 may also optionally include one or more support ribs 320 outside the seal 220 area to further reduce the impact of any internal pressure loads or handling loads on the seal 220 area with its thinner plastic.

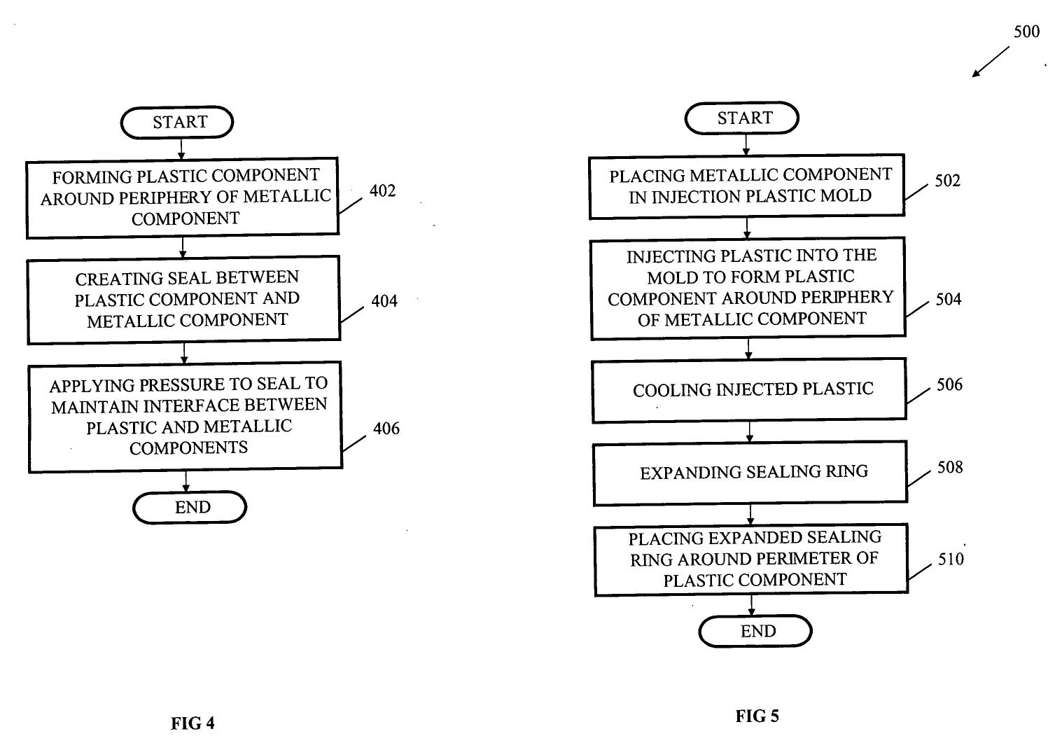

FIG. 4 depicts a flowchart of an embodiment to provide a seal between a metallic component and a plastic component. In one embodiment, one or more components of a cold plate system 100 and/or a manufacturer of a cold plate system 100 may perform the elements of flowchart 400. In the depicted embodiment, flowchart 400 begins with element 402, forming a plastic component around the periphery of a metallic component. An example methodology for forming a plastic component around the periphery of a metallic component is described subsequently in relation to elements 502 through 506 of FIG. 5. In one embodiment of element 402, a thermoplastic housing 102 (the plastic component) may be formed around a cold plate 104 (the metallic component), as described in relation to FIG. 1. In another embodiment, a thermoplastic fitting 302 (the plastic component) may be formed around a metallic fitting 304 (the metallic component), as described in relation to FIG. 3.

As part of forming a plastic component around a metallic component at element 402, a seal may be created between the plastic component and the metallic component at element 404. By forming the plastic component on the surface of the metallic component, any irregularities or other disturbances to the metallic surface can be accounted for as the molten plastic will naturally form itself precisely around the particular shape of the metallic surface. This may therefore provide a seal between the two components. By itself, however, and absent subsequent element 406, such a seal may degrade in performance if the plastic component is subjected to thermal fluctuations or other perturbations, as any creep or other change to the shape of the plastic component may result in reduced quality of the fit between the metallic and plastic components and thus the quality of the seal.

After the seal has been created, the method of flow chart 400 may continue to element 406, where a seal ring 106, 306 may apply pressure to the seal to maintain the interface between the plastic and metallic components, after which the flow chart terminates. By applying pressure to the plastic component at or near the seal, the seal ring 106, 306 may help keep the plastic component in contact with the metallic component during temperature or pressure fluctuations, helping to preserve the metallic-plastic seal. The amount of pressure applied by the seal ring 106, 306 may impact how tightly the metallic and plastic components are pushed together and may also impact the integrity and/or effectiveness of the seal. More applied pressure, for example, may improve the effectiveness of the seal.

FIG. 5 depicts a flowchart of an embodiment to create a plastic component around a metallic component and to seal the interface between them. In one embodiment, a manufacturer of a cold plate system 100 or other type of system may perform the elements of flowchart 500. A manufacturer (which may include a human and/or automated manufacturing process) may utilize any type of plastic component or metallic component. For example, the thermoplastic housing 102 may serve as the plastic component and the cold plate 104 may serve as the metallic component. In another example, a thermoplastic fitting 302 may serve as the plastic component while a metallic fitting 304 may serve as the metallic component.

In the depicted embodiment, flowchart 500 begins with element 502, placing a metallic component in an injection plastic mold. In one example, a manufacturer may place a cold plate 104 in an injection plastic mold. After placing the metallic component in the mold, the manufacturer may inject molten plastic into the mold and around the metallic component at element 504 to form the plastic component around the periphery of the metallic component. By injecting, or shooting, the plastic around the metallic component, the plastic component may be formed precisely around the particular metallic component, potentially providing a smoother interface and superior seal. The injection plastic mold accordingly is configured to handle both the metallic component and the eventual plastic component. After injecting the plastic, the method of flow chart 500 may continue to optional element 506, cooling the injected plastic. In this element, the injected molten plastic may be allowed to passively cool and harden or actively cooled in order to speed up the hardening process.

After the plastic component has been formed (and optionally cooled), the sealing ring 106, 306 is installed. At element 508, the sealing ring 106, 306 is expanded, such as by mounting the ring on an assembly tool that expands the circumference of the sealing ring 106, 306. After expanding the ring at element 510, the method of flow chart 500 continues to element 510, where the expanded ring is placed around the perimeter of the plastic component at the location on the plastic component where a seal is desired. The expanded ring, when placed around the perimeter, may then contract when it is removed from the assembly tool. After contraction, the sealing ring 106, 306 may then be tightly positioned around the plastic component, thus providing a compressive spring force to the plastic component, improving the seal at that location. The size (i.e., diameter) of the sealing ring 106, 306 relative to the part of the plastic component on which it will be placed may accordingly impact the amount of force provided by the sealing ring 106, 306. A relatively small sealing ring 106, 306 that has to be significantly expanded to fit around the plastic component, for example, may provide a large amount of compressive spring force to the plastic component. The effort to expand the sealing ring 106, 306, in this example will also be higher. A sealing ring 106, 306 that is closer in size to its ultimate destination, on the other hand, will provide less compressive force but will be easier to expand. While installation of the sealing ring 106, 306 by expanding and placing the expanded sealing ring 106, 306 has been described, other alternative are possible, such as by wrapping a sealing ring 106, 306 around the plastic component. After the sealing ring 106, 306 has been installed, flow chart 500 terminates.

While certain operations have been described herein relative to a direction such as “above” or “below” it will be understood that the descriptors are relative and that they may be reversed or otherwise changed if the relevant structure(s) were inverted or moved. Therefore, these terms are not intended to be limiting.

It will be apparent to those skilled in the art having the benefit of this disclosure that the present invention contemplates a method and apparatus to generate a seal between metallic and plastic materials. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A cold plate system comprising:
a metallic cold plate, the metallic cold plate comprising a cold plate outer surface;
a thermoplastic housing formed around the metallic cold plate to create a seal between the thermoplastic housing and the metallic cold plate, the thermoplastic housing comprising an inner surface and an outer surface, and the inner surface being formed adjacent to and in contact with the cold plate outer surface; and
a sealing ring positioned on the thermoplastic outer surface to provide a compressive spring force to the thermoplastic housing at least partially at the seal between the thermoplastic housing and the metallic cold plate.

2. The cold plate system of claim 1, wherein the metallic cold plate is comprised of copper.

3. The cold plate system of claim 1, wherein the metallic cold plate is at least partially cylindrical.

4. The cold plate system of claim 1, wherein the cold plate outer surface is at least partially polished.

5. The cold plate system of claim 1, wherein the metallic cold plate is positioned adjacent a heat-generating component.

6. The cold plate system of claim 1, the thermoplastic housing comprising:
a housing structure region to substantially support structural loads on the thermoplastic housing;
a housing sealing region, the housing sealing region being thinner than the housing structure region; and
wherein the sealing ring is positioned on a portion of the thermoplastic outer surface associated with the housing sealing region.

7. The cold plate system of claim 1, wherein the thermoplastic housing is at least partially cylindrical.

8. The cold plate system of claim 1, wherein the thermoplastic housing is a pump housing.

9. The cold plate system of claim 1, wherein the sealing ring is a double turn laminar metallic ring.

10. The cold plate system of claim 1, wherein the sealing ring is a single turn laminar metallic ring.

11. The cold plate system of claim 1, wherein the sealing ring is circular.

12. A system comprising:
a metallic component, the metallic component comprising a metallic outer surface;
a thermoplastic component formed around the metallic outer surface to create a seal between the thermoplastic component and the metallic component, the thermoplastic component comprising an inner surface and an outer surface, and the thermoplastic inner surface being formed adjacent to and in contact with the metallic outer surface; and
a sealing ring positioned on the outer surface of the thermoplastic component to provide a compressive spring force to the thermoplastic component, wherein the force applied to the thermoplastic component improves the seal between the thermoplastic component and the metallic component.

13. The system of claim 12, wherein the metallic component is at least partially cylindrical, and wherein further the thermoplastic component is at least partially cylindrical.

14. The system of claim 12, wherein the metallic component is a metallic cold plate, and wherein further the thermoplastic component is a thermoplastic housing of a pump.

15. The system of claim 12, wherein the metallic component is a metallic fitting, and wherein further the thermoplastic component is a thermoplastic fitting.

16. The system of claim 12, wherein the metallic outer surface is at least partially polished.

17. The system of claim 12, wherein the sealing ring is a double turn laminar metallic ring.

18. The system of claim 12, wherein the sealing ring is a single turn laminar metallic ring.

19. A method for joining a plastic component to a metallic component, the method comprising:
placing the metallic component into an injection plastic mold;
injecting plastic into the injection plastic mold to form a plastic component around the metallic component;
installing a sealing ring around at least a portion of the plastic component to provide a seal between the metallic component and the plastic component.

20. The method of claim 19, further comprising after injecting the plastic into the injection plastic mold, actively cooling the injected plastic.

21. The method of claim 19, further comprising after injecting the plastic into the injection plastic mold and before placing the sealing ring around at least a portion of the plastic component, allowing the injected plastic to cool.

22. The method of claim 19, wherein the injected plastic is molten plastic.

23. The method of claim 19, wherein installing the sealing ring comprises:
expanding the sealing ring; and
placing the expanded sealing ring around at least a portion of the plastic component.

24. A method for sealing an interface between a metallic component and a plastic component, the method comprising:
forming the plastic component around the metallic component;
creating a seal at an interface between the plastic component and the metallic component; and
applying pressure to the seal to maintain the interface between the plastic component and the metallic component.

25. The method of claim 24, wherein forming the plastic component comprises injecting plastic into an injection plastic mold around the metallic component.

26. The method of claim 24, wherein applying pressure to the seal comprises applying pressure the seal with a sealing ring.
